(19) United States
(12) Patent Application Publication
(10) Pub. No.: US 2015/0250345 A1
(43) Pub. Date: Sep. 10, 2015

(54) CAMPFIRE KETTLE

(71) Applicants: Michael John Johnston, South Slocan (CA); Paris Voykin, South Slocan (CA)

(72) Inventors: Michael John Johnston, South Slocan (CA); Paris Voykin, South Slocan (CA)

(21) Appl. No.: 14/199,720

(22) Filed: Mar. 6, 2014

(51) Int. Cl. A47J 27/21; A47J 33/00

(52) U.S. Cl. CPC A47J 27/21166; A47J 33/00

(57) ABSTRACT

An apparatus for heating fluids over a campfire comprises a hollow, horizontally positioned heating chamber extending between front and rear ends and having a top surface and an undersurface, the undersurface having a non-campfire exposed front end, and a campfire-exposed rear end. The apparatus further comprises at least two pairs of support members attached to the undersurface of the chamber and at a distance from the front and rear ends such that the chamber is partially suspended over the campfire when a rearmost pair of support members are placed in the campfire. A method for safely heating water in an apparatus by a campfire comprising the apparatus comprises positioning the rear end of the apparatus within the fire's perimeter and the front end outside the fire's perimeter, dispensing water from the fluid control valve on the front end and adding water to the aperture on the top surface.

### BACKGROUND OF THE INVENTION

1. Field of Invention The present invention relates generally to a portable stove for heating hot water over a campfire. In particular, the stove may sit on the edge of the fire, and is thus not required to sit straddling or over the fire.

2. Description of Related Art Heating water over a campfire has traditionally been done with a pot or kettle placed on top of the fire, such as by sitting atop of a grill placed on or directly over the fire, or by suspending it in the air over the fire. Using a pot or kettle limits the amount of water that may be heated at any one time. Precautions must also be taken to safely monitor and remove the pot-kettle from the fire before it over boils.

Additionally, it is a cumbersome procedure to dispense and then refill the pot-kettle as hot water is used and more is heated. In one method, water is dispensed and refilled by the user leaning over the fire and using a dipping device (e.g. ladle, cup, etc.). This method poses a risk to the user in the event that they slip and fall into the fire, and/or the fire emits sparks or other heated debris. In another method, the user lifts the pot-kettle off of the fire, empties and refills it, and then places it back over the fire. This is a laborious method, and it requires a significant amount of time to completely reheat a pot-kettle filled with cold water.

The prior art, though, discloses a few apparatuses that attempt to resolve these deficiencies by providing, for example, stoves that can be placed over the fire to heat larger amounts of water and that do not require transferring, and/or risk spilling, the hot water. For example, U.S. Pat. No. 5,421,042 to Hibschman (1995) teaches a large pot suspended in the air over a fire, and from which a spout is used to produce an outdoor shower. And yet, suspending a large, heavy container holding hot water—especially a shoulder level—is not an easy or safe task, especially in the wilderness.

Likewise, U.S. Pat. No. 5,203,316 to Pritchett (1993) discloses a portable camp stove that sits directly over a fire built into a pit. Unfortunately, pit fires are difficult to maintain due to the limited circulation of oxygen, and this particular stove precludes heating or cooking anything else over or near the fire.

And U.S. Pat. No. 3,292,609, to Powell (1966), teaches a portable, collapsible square heating chamber with a pouring spout for use in camping. The chamber rests on two square support members comprising long rectangular ends that rest on the ground to bear the weight of the chamber, and that are vertically aligned with and the same length as the chamber. As a result, the support members must straddle the fire, which limits the size of the campfire, or else the support members must lie within the embers. If it is the latter, then the support members must comprise material that does not easily conduct heat and succumb to damage from repeated exposures to fire.

Additionally, U.S. Pat. No. 6,520,173 to Lautner (2003) discloses a portable stove that sits over and/or within a fire using legs forming a tripod. Again, the fire must be small to fit within the area of the tripod legs, or the legs must comprise material that does not easily conduct heat and succumb to damage from repeated exposures to fire.

What is needed within the art is a portable camping kettle that safely heats and dispenses relatively large amounts of water (as compared to prior apparatuses and traditional pots), and that does not require any part of the apparatus, including the legs, to sit directly within the campfire while also not limiting the size of or impeding the fire. It is also desirable that the apparatus be able to dispense hot water and be refilled with cold water for heating without the user having to remove the apparatus from the fire and/or risk injury by leaning over the fire.

### SUMMARY OF THE INVENTION

According to a first embodiment of the present invention there is disclosed an apparatus for heating fluids over a campfire comprising a hollow, horizontally positioned heating chamber extending between front and rear ends and having a top surface and an undersurface, the undersurface having a non-campfire exposed front end, and a campfire-exposed rear end. The apparatus further comprises at least two pairs of support members attached to the undersurface of the chamber and at a distance from the front and rear ends such that the chamber is partially suspended over the campfire when a rearmost pair of support members are placed in the campfire.

The apparatus may further comprise a handle to lift and maintain the apparatus horizontally, wherein the handle is mounted on the top surface of the chamber.

The apparatus may further comprise a fluid flow control valve for draining heated fluid safely from the apparatus without exposing a user to the campfire, wherein the control valve is positioned on the front end of the chamber. The control valve may comprise a welded ball valve with an open and a closed position.

The apparatus may further comprise an aperture for adding fluid to the chamber without exposing a user to the campfire, wherein the aperture is positioned on the top surface of the chamber near the front end. The aperture may comprises a reducer with a hinged cap affixed to an outer surface of the reducer.

Each of the pair of support members may comprise a pair of legs extending from the undersurface at 45 degrees from each other. The chamber may be cylindrical. The chamber may be rectangular.

According to a further embodiment of the present invention there is disclosed a method for safely heating water in an apparatus by a campfire, the method comprising positioning an apparatus to be suspended over a campfire. The apparatus comprises a hollow, horizontally positioned heating chamber extending between front and rear ends and having a top surface, an undersurface, a non-campfire exposed front end. The apparatus further comprises a campfire-exposed rear end and at least two pairs of support members attached to the undersurface of the chamber and at a distance from the front and rear ends such that the chamber is partially suspended over the campfire when a rearmost pair of support members are placed in the campfire. The apparatus further comprises a fluid flow control valve for draining heated water safely from the apparatus without exposing a user to the campfire, wherein the control valve is positioned on the front end of the chamber and an aperture for adding water to the chamber, wherein the aperture is positioned on the top surface of the chamber proximate to the front end. The apparatus may be positioned with the rear end within the fire's perimeter and the front end outside the fire's perimeter. The method further comprises dispensing water from the fluid control valve on the front end without exposing the user to the campfire and adding water to the aperture from the front end without exposing the user to the campfire.

The chamber may be cylindrical. The aperture may comprise a reducer with a hinged cap affixed to an outer surface of the reducer. The control valve may comprises a welded ball valve with an open and a closed position.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for heating fluids according to a first embodiment of the present invention.

FIG. 2 is a detailed end view of front end of the apparatus of FIG. 1.

FIG. 3 is a detailed view of the top of the apparatus of FIG. 1.

### DETAILED DESCRIPTION

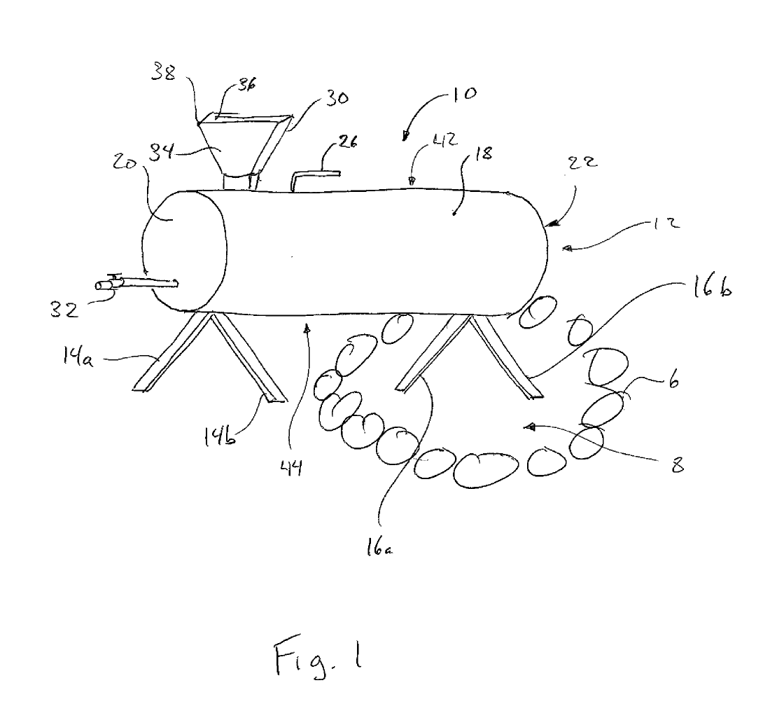

Referring to FIG. 1, an apparatus for heating fluids over a campfire according to a first embodiment of the invention is shown generally at 10. The apparatus 10 comprises a cylindrical chamber 12, with a pair of front leg support members 14a,b and a pair of rear leg support members 16a,b. The cylindrical chamber is formed of an outer cylindrical wall 18, and a non-fire facing front end plate 20 and a fire facing rear end plate 22. The chamber 12 further includes a top aperture 30 for adding more water and a fluid flow control valve 32 for pouring or draining hot water out of the apparatus 10.

The outer cylindrical wall 18, as well as the front end 20 and the rear end 22, comprise heat conducting and weather resistant material, such as stainless steel, by way of non-limiting example. The front end 20 and rear end 22 may also comprise outward curved (i.e. convex) or flat plates secured to the outer cylindrical wall 18 by welding, adhesives or the like so as to form a reservoir therein.

The chamber 12, in the present embodiment, may be selected to form a reservoir capable of containing a liquid having dimensions approximately twenty inches (508 mm) in length and eight inches (203 mm) in diameter. Although a cylindrical shape is described and shown, it will be appreciated that other shapes for the chamber 12 may also be utilized, such as, by way of non-limiting example, rectangular, square, etc. and other dimensions such that when the apparatus is configured horizontally in relationship to the ground, it is of sufficient length to have part of the apparatus near or over the fire for heating the water, and part safely away for dispensing and refilling it with water. As illustrated, the chamber 12 comprises a top surface 42 and a bottom surface 44 extending along the top and bottom surfaces, respectively thereof.

As shown in FIG. 1, the leg support members 14a,b and 16a,b also comprise tubular structures able to withstand repeated exposure to high degrees of heat, such as flat rectangular or cylindrical stainless steel 316 (SS316) members, and without losing their structural configuration and weight bearing capabilities. In the exemplified embodiment, the pairs of legs 14a,b and 16a,b are about six to eight inches (152 to 208 mm) in length, and 0.75 inches (19 mm) in width. Furthermore, each leg within the pair 14a,b and 16a,b may be configured at approximately a forty-five degree angle to the other leg within the pair (i.e. see FIG. 1, leg 14a is about forty degrees in configuration to leg 14b).

Additionally, each leg support member within the pair 14a,b and 16a,b may attach to a center longitudinal axis (not shown) on the underside 44 of the heating chamber 12. Alternatively, they may be spaced slightly apart (e.g. two-four inches) straddling the longitudinal axis running between the front end 20 and rear end 22 of the apparatus. Means of attachment of the leg support members to the underside 44 of the heating chamber 12 are well known to the artisan, and may comprise, for example, welding, adhesives or fasteners, by way of non-limiting example.

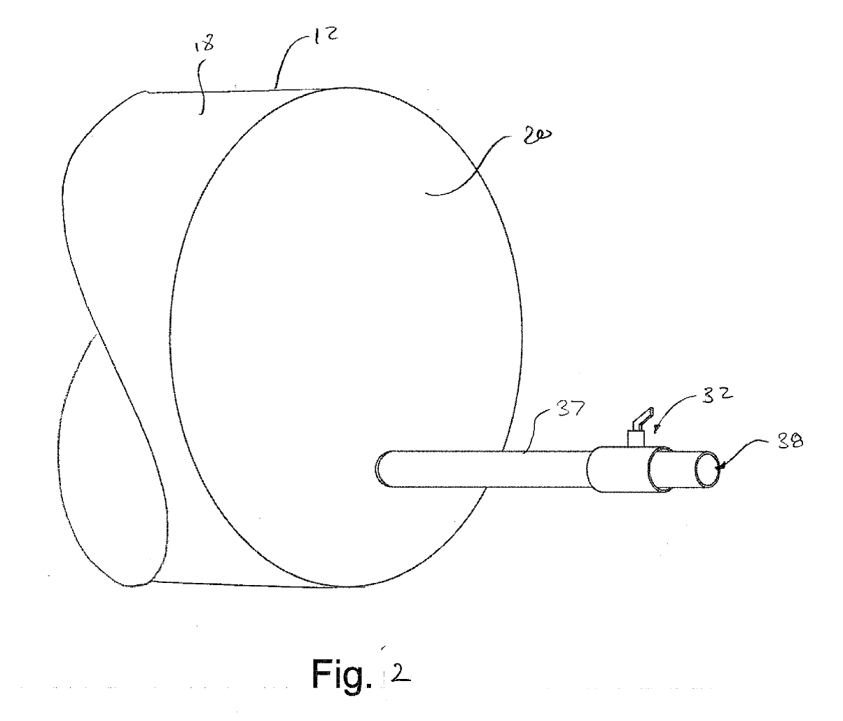

One safety feature of the apparatus 10 comprises that the pairs of legs 14a,b and 16a,b be located away from the front end 20 and the rear end 22 of the heating chamber 12, respectively as illustrated in FIG. 2. By way of non-limiting example, the pairs of legs 14a and b and 16a and b may be spaced apart from the front and rear ends 20 and 22 by as distance approximately one quarter to one third of the length of the apparatus. When the apparatus 10 is placed within the perimeter 6 of a fire without interfering with or being touched by it, as shown in FIG. 1, then the rear section comprising the rear end 22, as well as about one-quarter to one-third of the rear surface area of the chamber 12, lies over or near the fire. As a result, a sufficient surface area of the apparatus 10 is exposed to the fire to efficiently heat all of the water within the heating chamber 12, but without heating the majority of the apparatus's surface, which would make it dangerous to touch. The durability of the apparatus is also prolonged by not repeatedly exposing any part of the apparatus directly to the fire.

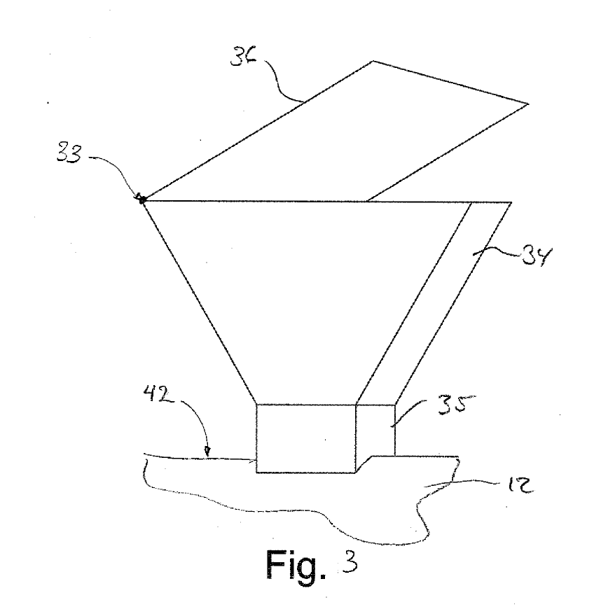

Another safety feature of apparatus 10 comprises the user not being required to move the apparatus 10 in order to drain and/or refill it with water. Therefore, the user is not at risk for accidentally spilling hot water. To that end, the heating chamber 12 further comprises an aperture 30 for adding water to the apparatus 10 from its front end 20 and away from the fire. In the exemplified embodiment of FIG. 3, the aperture houses a two to three inch reducer 34 or funnel in fluidic communication with an interior of the chamber 12 that is covered by a cap plate 36 secured to the reducer 34 by a hinge 33 or the like as illustrated in FIG. 3. It is noted, though, that other permanent or removable means for pouring water into the heating chamber 12 at aperture 30 are readily suitable for use with apparatus 10, such as funnels, cups, etc. Optionally, the reducer 34 may be spaced apart from the top surface 42 of the chamber 12 by a pipe 35 or the like.

In addition to the aperture 30 for adding water, the apparatus 10 also comprises a fluid flow control valve 32 for draining or pouring water from the heating chamber 12. In the exemplified embodiment of FIG. 2, the fluid flow control valve 32 may include a pouring spout 38 and be spaced apart from the front end 20 by a pipe 37 or the like. The valve 32, spout 38 and pipe 37 may all be made from ss316 or the like.

Not only do the aperture 30 and the fluid flow control valve 32 provide safety to the user by being on the non-fire side front end 20 of the apparatus 10, they also enable the user to maintain the water at a fairly constant temperature as more and more water is consumed. This prevents the user from having to wait to reheat water, again and again, as more is dispensed. In the present invention, the user may drain hot water from the fluid flow control 32 at the front end 20, and add more cold or ambient temperature water via the top aperture 30 as needed. By removing and then adding relatively small percentages of the total volume of the chamber 12, then the water is quickly re-heated and/or maintained within a desired range of temperatures (i.e. safe for drinking and touching versus boiling).

In addition to the safety features, the apparatus 10 is easily portable for movement around a fire and campsite. For example, the leg support members 14a,b and 16a,b may include the ability to collapse or fold-up, and/or be removable for transporting the apparatus, such as into and out of a remote campsite according to methods which are commonly known such as hinges, pins or the like. Additionally, the apparatus 10 is suited for ease of transport due to a lifting handle 26 affixed to the top surface of the apparatus 10 along its longitudinal axis. In the exemplified embodiment, the handle 26 is located about the same distance as rear legs 16a,b from the rear end 22 (i.e. distance 24), so that the apparatus 10 may be safely lifted away from a fire and balanced by the user even when the apparatus 10 is filled with water. The skilled artisan would readily know of multiple types of handles (e.g. rings, latches, straps, etc.) that may be attached to various surface areas of heating chamber 12. For example, and as depicted in the exemplified embodiment of FIG. 1, the handle 26 may comprise a one-quarter inch to a one-inch flat bar although other handle types may also be utilized.

While specific embodiments of the invention have been described and illustrated, such embodiments should be considered illustrative of the invention only and not as limiting the invention as construed in accordance with the accompanying claims.

What is claimed is:

1. An apparatus for heating fluids over a campfire comprising:
a hollow, horizontally positioned heating chamber extending between front and rear ends and having a top surface and an undersurface, said undersurface having a non-campfire exposed front end, and a campfire-exposed rear end; and
at least two pairs of support members attached to said undersurface of said chamber and at a distance from said front and rear ends such that said chamber is partially suspended over the campfire when a rearmost pair of support members are placed in the campfire.

2. The apparatus of claim 1 further comprising a handle to lift and maintain the apparatus horizontally, wherein said handle is mounted on said top surface of said chamber.

3. The apparatus of claim 1 further comprising a fluid flow control valve for draining heated fluid safely from the apparatus without exposing a user to the campfire, wherein said control valve is positioned on said front end of the chamber.

4. The apparatus of claim 3, wherein said control valve comprises a welded ball valve with an open and a closed position.

5. The apparatus of claim 1 further comprising an aperture for adding fluid to said chamber without exposing a user to the campfire, wherein said aperture is positioned on the top surface of said chamber near said front end.

6. The apparatus of claim 5, wherein said aperture comprises a reducer with a hinged cap affixed to an outer surface of said reducer.

7. The apparatus of claim 1, wherein each of said pair of support members comprises a pair of legs extending from said undersurface at 45 degrees from each other.

8. The apparatus of claim 1, wherein said chamber is cylindrical.

9. The apparatus of claim 1, wherein said chamber is rectangular.

10. A method for safely heating water in an apparatus by a campfire, the method comprising:
positioning an apparatus to be suspended over a campfire, wherein said apparatus comprises,
a hollow, horizontally positioned heating chamber extending between front and rear ends and having a top surface, an undersurface, a non-campfire exposed front end, and a campfire-exposed rear end;
at least two pairs of support members attached to said undersurface of said chamber and at a distance from said front and rear ends such that said chamber is partially suspended over the campfire when a rearmost pair of support members are placed in the campfire;
a fluid flow control valve for draining heated water safely from the apparatus without exposing a user to the campfire, wherein said control valve is positioned on said front end of said chamber;
an aperture for adding water to said chamber, wherein said aperture is positioned on said top surface of said chamber proximate to said front end;
wherein when the apparatus is positioned with said rear end within the fire's perimeter and said front end outside the fire's perimeter;
dispensing water from said fluid control valve on said front end without exposing the user to the campfire; and,
adding water to the aperture from said front end without exposing the user to the campfire.

11. The method of claim 10, wherein said chamber is cylindrical.

12. The method of claim 10, wherein said aperture comprises a reducer with a hinged cap affixed to an outer surface of said reducer.

13. The apparatus of claim 10, wherein said control valve comprises a welded ball valve with an open and a closed position.
